(19) United States
(12) Patent Application Publication
(10) Pub. No.: US 2009/0020612 A1
(43) Pub. Date: Jan. 22, 2009

(54) IMAGING DUAL WINDOW SCANNER WITH PRESENTATION SCANNING

(75) Inventors: Mark Drzymala, Commack, NY (US); Edward D. Barkan, Miller Place, NY (US)

Correspondence Address: Tarolli, Sundheim, Covell & Tummino L.L.P, 1300 East Ninth Street, Suite 1700, Cleveland, OH, 44114, US

(73) Assignee: Symbol Technologies, Inc., Holtsville, NY (US)

(21) Appl. No.: 12/241,153

(22) Filed: Sep. 30, 2008

Related U.S. Application Data
(63) Continuation-in-part of application No. 11/823,818, filed on Jun. 28, 2007.
Application No. 11/823,818 is a continuation-in-part of application No. 12/112,275, filed on Apr. 30, 2008.

(51) Int. Cl. G06Q 30/00

(52) U.S. Cl. 235/462.32

(57) ABSTRACT

A method and apparatus are provided comprising a dual window scanner (10, 200, 400) for imaging a target bar code (30) on a target object (32). The dual window scanner comprises a housing (20) supporting two transparent windows (V, H) and defining an interior region (18). The dual window scanner further comprises an imaging system including a plurality of cameras (C1-C6) wherein each camera is positioned within the housing interior region (18) and defines a field-of-view which is different than a field-of-view of each other camera of the plurality of cameras, each camera includes a sensor array (40). Each camera in the plurality of cameras located within the housing for directing the respective field-of-views such that the field-of-views substantially fill the surface of the two transparent windows.

### CROSS REFERENCE TO RELATED APPLICATIONS

The following application is a Continuation-in-Part application of U.S. application Ser. No. 11/823,818 filed Jun. 28, 2007 entitled IMAGING READER WITH PLURAL SOLID-STATE IMAGERS FOR ELECTRO-OPTICALLY READING INDICIA and is also a Continuation-in-Part application Ser. No. 12/112,275 filed Apr. 30, 2008 entitled BAR CODE READER HAVING MULTIPLE CAMERAS. The following application claims priority to the above-identified applications, which are incorporated herein by reference in their entireties for all purposes.

### TECHNICAL FIELD

The present disclosure relates to a multiple camera imaging-based bar code reader.

### BACKGROUND

Various electro-optical systems have been developed for reading optical indicia, such as bar codes. A bar code is a coded pattern of graphical indicia comprised of a series of bars and spaces of varying widths, the bars and spaces having differing light reflecting characteristics. The pattern of the bars and spaces encode information. Bar code may be one dimensional (e.g., UPC bar code) or two dimensional (e.g., DataMatrix bar code). Systems that read, that is, image and decode bar codes employing imaging camera systems are typically referred to as imaging-based bar code readers or bar code scanners.

Imaging-based bar code readers may be portable or stationary. A portable bar code reader is one that is adapted to be held in a user's hand and moved with respect to a target indicia, such as a target bar code, to be read, that is, imaged and decoded. Stationary bar code readers are mounted in a fixed position, for example, relative to a point-of-sales counter. Target objects, e.g., a product package that includes a target bar code, are moved or swiped past one of the one or more transparent windows and thereby pass within a field-of-view of the stationary bar code readers. The bar code reader typically provides an audible and/or visual signal to indicate the target bar code has been successfully imaged and decoded. Sometimes barcodes are presented, as opposed to swiped. This typically happens when the swiped barcode failed to scan, so the operator tries a second time to scan it. Alternately, presentation is done by inexperience users, such as when the reader is installed in a self check out installation.

A typical example where a stationary imaging-based bar code reader would be utilized includes a point of sale counter/cash register where customers pay for their purchases. The reader is typically enclosed in a housing that is installed in the counter and normally includes a vertically oriented transparent window and/or a horizontally oriented transparent window, either of which may be used for reading the target bar code affixed to the target object, i.e., the product or product packaging for the product having the target bar code imprinted or affixed to it. The sales person (or customer in the case of self-service check out) sequentially presents each target object's bar code either to the vertically oriented window or the horizontally oriented window, whichever is more convenient given the specific size and shape of the target object and the position of the bar code on the target object.

A stationary imaging-based bar code reader that has a plurality of imaging cameras can be referred to as a multi-camera imaging-based scanner or bar code reader. In a multi-camera imaging reader, each camera system typically is positioned behind one of the plurality of transparent windows such that it has a different field-of-view from every other camera system. While the fields of view may overlap to some degree, the effective or total field-of-view of the reader is increased by adding additional camera systems. Hence, the desirability of multicamera readers as compared to signal camera readers which have a smaller effective field-of-view and require presentation of a target bar code to the reader in a very limited orientation to obtain a successful, decodable image, that is, an image of the target bar code that is decodable.

The camera systems of a multi-camera imaging reader may be positioned within the housing and with respect to the transparent windows such that when a target object is presented to the housing for reading the target bar code on the target object, the target object is imaged by the plurality of imaging camera systems, each camera providing a different image of the target object. U.S. patent application Ser. No. 11/862,568 filed Sep. 27, 2007 entitled ‘Multiple Camera Imaging Based Bar Code Reader’ is assigned to the assignee of the present invention and is incorporated herein by reference.

### SUMMARY

One example embodiment of the present disclosure includes a dual window scanner for imaging a target bar code on a target object. The dual window scanner comprises a housing supporting two transparent windows and defining an interior region. A target object is presented in relation to the housing for imaging a target bar code. The dual window scanner also comprises an imaging system that includes a plurality of cameras wherein each camera is positioned within the housing interior region and defines a field-of-view which is different than a field-of-view of each other camera of the plurality of cameras. Each camera includes a sensor array. Each camera in the plurality of cameras located in the housing for directing the respective field-of-views such that the field-of-views substantially fill the surface of the two transparent windows.

Another example embodiment of the present disclosure includes a method of operating dual window scanner for imaging a target bar code comprising locating a plurality of imaging based cameras within a housing of a dual window scanner, each scanner having a respective field-of-view. The method also comprises extending the field-of-view of each camera beyond at least one window located in the housing. The method further comprises facilitating the extending of the field-of-views by at least one mirror associated to each camera thereby, forming scanning patterns on the surface of the at least one window located in the housing by the field-of-views such that the scanning patterns cover substantially the entire surface of the window or windows.

A further example embodiment of the present disclosure includes a dual window scanner for imaging a target bar code on a target object. The dual window scanner comprises housing means supporting one or more transparent windows and defines an interior region. A target object can be presented in relation to the housing means for imaging a target bar code. The dual window scanner further comprises imaging means that includes a plurality of camera assembly means wherein each camera assembly means is positioned within the housing means interior region and defines a field-of-view which is different than a field-of-view of each other camera assembly means of the plurality of camera assembly mean. The dual window scanner also comprises sensing means for each camera assembly means including a sensor array and an imaging lens assembly for focusing the field-of-view of the camera assembly means onto the sensor array. The dual window scanner yet further comprises reflective means associated with each camera assembly means for directing the respective field-of-views such that the field-of-views substantially fill the surface of the one or more transparent windows located in the housing means.

A yet further example embodiment of the present disclosure includes dual window scanner for imaging a target bar code on a target object. The dual window scanner comprises a housing comprising a substantially vertical window supported in an upper housing portion and a substantially horizontal window supported in a lower housing portion, the upper and lower housing portions defining an interior region of the dual window scanner. The dual window scanner further comprises an imaging system that includes a plurality of cameras positioned on a single printed circuit board within the housing interior region. Each camera is positioned within the housing interior region and defines a field-of-view which is different than a field-of-view of each other camera of the plurality of cameras. Each camera comprises a sensor array. The dual window scanner also comprises at least one mirror associated with at least one camera in the plurality of cameras. The field-of-views form an imaging pattern substantially filling the surface of the horizontal and vertical windows. The field-of-views are projected beyond the substantially vertical and horizontal windows in directions for scanning various sides of a package as it is swiped through a scan field formed by the fields-of-view.

### BRIEF DESCRIPTION OF THE DRAWINGS

The foregoing and other features and advantages of the present disclosure will become apparent to one skilled in the art to which the present disclosure relates upon consideration of the following description of the invention with reference to the accompanying drawings, wherein like reference numerals, unless otherwise described refer to like parts throughout the drawings and in which:

FIG. 1 is a perspective view of a bar code reader having a vertical and a horizontal window through which bar codes are viewed by multiple cameras within the reader constructed in accordance with one example embodiment of the present disclosure;

FIG. 1A is a perspective view of a laser scanner having a vertical and a horizontal window, illustrating scan patterns projected from laser scanners therein;

FIG. 2 is a perspective view of the reader of FIG. 1 with a portion of the reader housing removed to illustrate three cameras forming a portion of a plurality of cameras located on a printed circuit board;

FIGS. 3 and 4 are perspective views showing a position of three additional cameras forming a portion of a plurality of cameras located on a printed circuit board resulting in a total of six cameras constructed in accordance with one example embodiment of the present disclosure;

FIGS. 5 and 6 are plan views showing ray traces for cameras of a multi-camera bar code reader constructed in accordance with one example embodiment of the present disclosure;

FIG. 7 is a schematic block diagram of selected systems and electrical circuitry of the bar code reader of FIG. 1;

FIG. 8 is a flowchart of an exemplary embodiment of the present disclosure;

FIG. 9 is a perspective view of an imaging dual window scanner constructed in accordance with another example embodiment of the present disclosure;

FIG. 10 is a perspective view of the imaging dual window scanner of FIG. 9, projecting an imaging field-of-view from imaging camera C1 from a horizontal window;

FIG. 11 is a perspective view of the imaging dual window scanner of FIG. 10, illustrating an imaging pattern resulting from the field-of-view projected from camera C1;

FIG. 12 is a perspective view of the imaging dual window scanner of FIG. 9, projecting an imaging field-of-view from imaging camera C2 from a horizontal window;

FIG. 13 is a perspective view of the imaging dual window scanner of FIG. 12, illustrating an imaging pattern resulting from the field-of-view projected from camera C2;

FIG. 14 is a perspective view of the imaging dual window scanner of FIG. 9, projecting an imaging field-of-view from imaging camera C3 from a horizontal window;

FIG. 15 is a perspective view of the imaging dual window scanner of FIG. 14, illustrating an imaging pattern resulting from the field-of-view projected from camera C3;

FIG. 16 is a perspective view of the imaging dual window scanner of FIGS. 9-15, illustrating the imaging patterns resulting from the field-of-views projected from cameras C1, C2, and C3;

FIG. 17 is a perspective view of the imaging dual window scanner of FIG. 9, projecting an imaging field-of-view from imaging camera C4 from a vertical window;

FIG. 18 is a perspective view of the imaging dual window scanner of FIG. 17, illustrating an imaging pattern resulting from the field-of-view projected from camera C4;

FIG. 19 is a perspective view of the imaging dual window scanner of FIG. 9, projecting an imaging field-of-view from imaging camera C5 from a vertical window;

FIG. 20 is a perspective view of the imaging dual window scanner of FIG. 19, illustrating an imaging pattern resulting from the field-of-view projected from camera C5;

FIG. 21 is a perspective view of the imaging dual window scanner of FIG. 9, projecting an imaging field-of-view from imaging camera C6 from a vertical window;

FIG. 22 is a perspective view of the imaging dual window scanner of FIG. 21, illustrating an imaging pattern resulting from the field-of-view projected from camera C6;

FIG. 23 is a perspective view of the imaging dual window scanner of FIGS. 9 and 17-22, illustrating the imaging patterns resulting from the field-of-views projected from cameras C4, C5, and C6;

FIG. 24 is a perspective view of the imaging dual window scanner of FIGS. 9-23, illustrating the imaging patterns resulting from the field-of-views projected from cameras C1, C2, C3, C4, C5, and C6;

FIG. 25 is an exploded assembly view of a dual window scanner constructed in accordance with one example embodiment of the present disclosure; and

FIG. 26 is a flowchart of an exemplary embodiment of the present disclosure.

### DETAILED DESCRIPTION

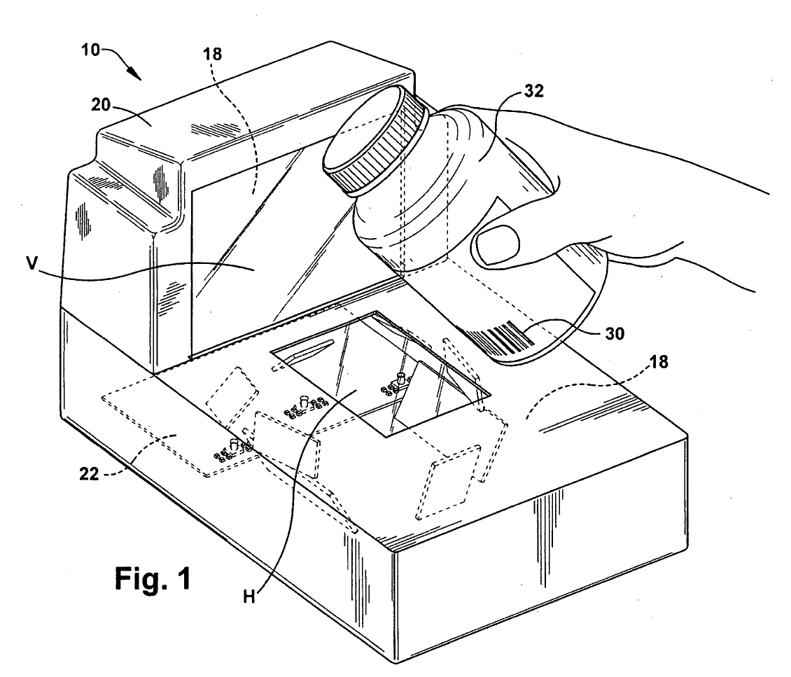

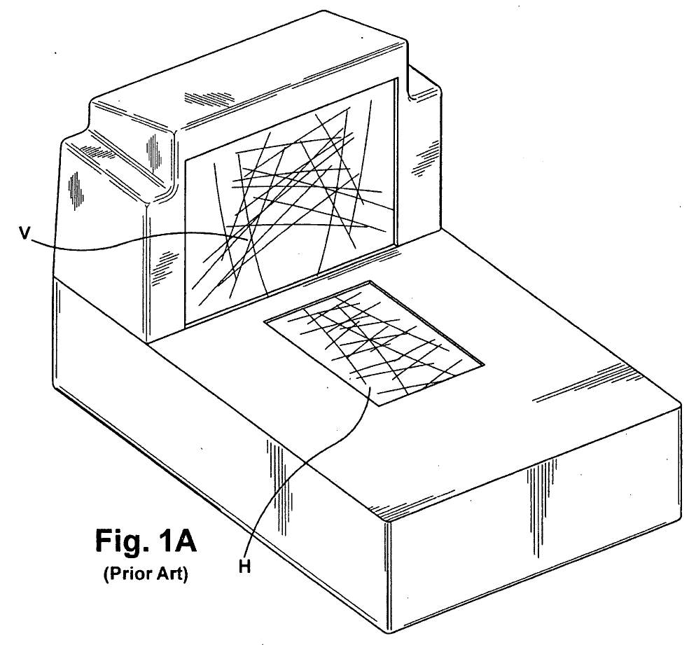

The present disclosure relates to a multiple camera imaging-based bar code reader. In particular, the disclosure comprises a dual window scanner having a plurality of imaging cameras positioned such that field-of-views projecting from each of the cameras fill both a horizontal and a vertical window located in the housing of the dual window scanner. Thus repeated swipes of the product or indicia to be scanned across the scanner are reduced compared to conventional dual window laser scanners that produces holes in the scanning field-of-view, as illustrated in FIG. 1A.

In addition, the present disclosure provides a dual window scanner in which its construction is optimized to work well when the target indicia is presented or swiped. The positioning of the plurality of imaging cameras, as discussed below provides enhanced presentation scanning, while the long optical paths, high frame rate of the imagers, sequential readout of the cameras, angles in which the field-of-views are projected from the cameras beyond the windows of the cameras additionally facilitate reading the target indicia when the target object is swiped, allowing the reading of a target indicia on any side of the target object when it passes through the scan field. The dual window scanner of the present disclosure further projects various fields-of-view from the plurality of imaging cameras beyond the dual windows in directions appropriate for scanning various sides of a package that is swiped or presented through or into the scanned field.

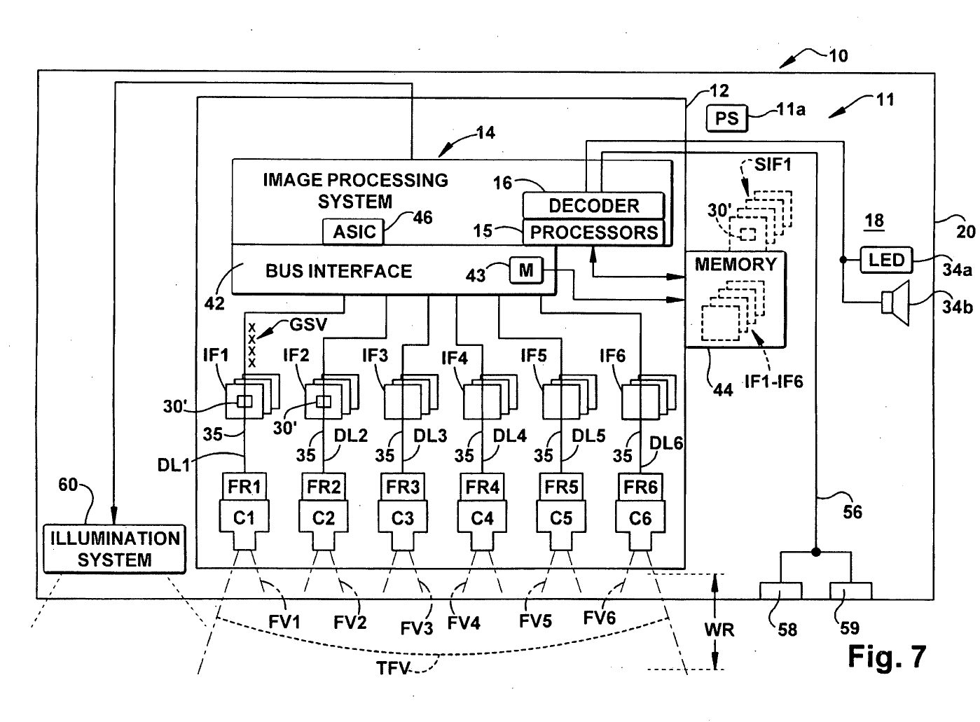

An exemplary embodiment of a multi-camera imaging-based bar code scanner or reader 10 of the present invention is shown schematically in the Figures. As depicted in FIG. 7, the bar code reader 10 includes circuitry 11 comprising an image system 12 which includes a plurality of imaging cameras C1, C2, C3, C4, C5, C6, which produce raw gray scale images, and an image processing system 14, which includes one or more processors 15 and a decoder 16 that analyzes the gray scale images from the cameras and decodes imaged target bar codes, if present. The imaging system 12 is capable of reading, that is, imaging and decoding both 1D and 2D bar codes and postal codes. The reader 10 is also capable of capturing images and signatures. The decoder 16 may be integrated into the reader 10 or may be a separate system, as would be understood by one of skill in the art.

In one exemplary embodiment, the reader 10 is stationary and the image and decoder systems are supported within an interior region 18 of a housing 20 (see FIG. 1). The housing 20 may be integrated into a sales counter that of a point of sales system that includes, for example, a cash register, a touch screen visual display or other type user interface and a printer for generating sales receipts. The housing 20 depicted in FIG. 1 includes two transparent windows H, V.

In the exemplary embodiment, the cameras C1-C6 are mounted to a printed circuit board 22 inside the housing and each camera defines a two-dimensional field-of-view FV1, FV2, FV3, FV4, FV5, FV6. Positioned behind and adjacent to the windows H, V are reflective mirrors M in that help define a given camera field-of-view such that the respective fields-of-view FV1-FV6 pass from the housing 20 through the windows creating an effective total field-of-view (TFV) for the reader 10 in a region of the windows H, V, outside the housing 20. Because each camera C1-C6 has an effective working range WR (shown schematically in FIG. 7) over which a target bar code 30 may be successfully imaged and decoded, there is an effective target area in front of the windows H, V within which a target bar code 30 presented for reading may be successfully imaged and decoded.

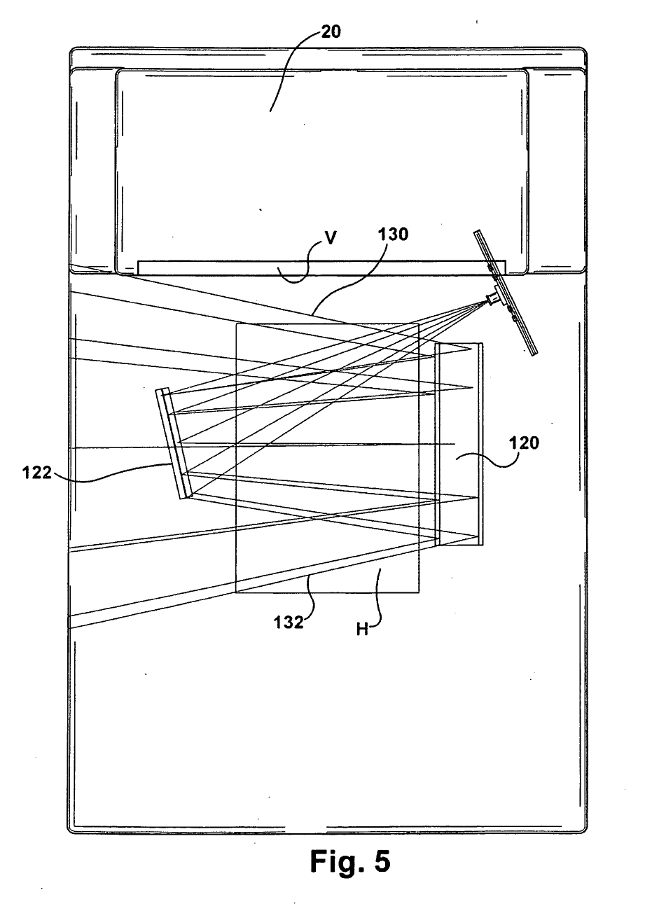

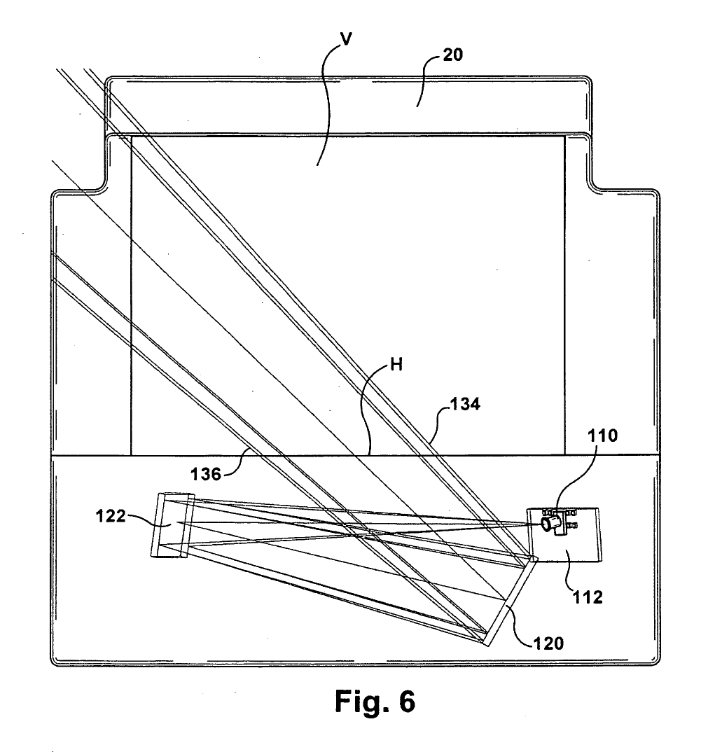

FIGS. 5 and 6 illustrate an alternative example embodiment comprising an alternative camera arrangement for a multi-camera bar code reader. One camera 110 (of a multiple number of such cameras) has a support 1112 that positions the camera 110 for receipt of light from a field-of-view having borders or bounds 130, 132, 134, 136 and which images objects through the horizontal window H. This field-of-view is defined in part by two focusing mirrors 120, 122 that tend to concentrate light originating within the field-of-view to the camera 112. In this arrangement, each camera would include its own support rather than multiple cameras on a single pc such as shown in FIG. 1.

In accordance with one use, either a sales person or a customer will present a product or target object 32 selected for purchase to the housing 20. More particularly, a target bar code 30 imprinted or affixed to the target object 32 will be presented in a region near the windows H, V for reading, that is, imaging and decoding of the coded indicia of the target bar code. Upon a successful reading of the target bar code, a visual and/or audible signal will be generated by the reader 10 to indicate to the user that the target bar code 30 has been successfully imaged and decoded. The successful read indication may be in the form of illumination of a light emitting diode (LED) 34a (FIG. 7) and/or generation of an audible sound by a speaker 34b upon appropriate signal from the decoder 16.

Generally, upon repetitive use of the reader 10, a user (sales person or customer) will intuitively orient and move the target object toward the windows H, V in such a way that the target bar code 30 moves in relation to a given window and even a particular region of a window in the same way and same orientation time after time. As shown in FIG. 1, a typical user may orient the target object 32 such that the target bar code 30 is facing the window H and is approximately centered with respect to the window H. Thus, for this particular user, it would likely be the case that the target bar code 30 would be suitably imaged for decoding purposes generally by either the camera C1 or the camera assembly C3 which are positioned to monitor objects moved past the window H. As seen in FIG. 1, however, the object 30 is tilted so that the camera C3 is more likely to view and properly decode the bar code 30.

Even though users tend to use the same part of a window most of the time, they will sometimes use the other window, particularly when the object is too bulky to re-orient to use the window that they usually use. Whenever they use the second window, people will tend to move the barcode through the same area of that window, so a preferred area for both windows can be independently determined based on statistical records. If the user most often uses, for example, the vertical window, the decoder will examine images from the most commonly used camera behind the vertical window first, in the part of the field-of-view of that camera where barcodes have most frequently been found. If no barcode is found, the decoder will eventually examine the images from the horizontal window, starting with the camera, and the area within the field-of-view of that camera where barcodes are most commonly found.

A newly installed scanner initially uses a fixed search pattern since no statistics for a particular user will have yet been gathered. Similarly, a casual user such as a customer at a checkout will not have developed a unique use pattern. The decoder 16 adopts a statistically driven pattern when enough barcodes have been decoded to reveal a pattern. The search pattern used for a new scanner can concentrate in areas found to be most frequently used by a broad cross-section of users to maximize the chances of rapidly finding the barcode even before enough data has been gathered to optimize the reader to a particular user. Stated another way, a weighted search pattern can be used to advantage even without altering the search pattern based on statistical behavior of an individual user.

Before a barcode can be decoded by an imaging barcode scanner, the barcode must be located within the field-of-view of the scanner. This is a computationally intensive process. Various search patterns have been devised to attempt to locate the barcode as rapidly as possible, but since people who use barcode scanners do not all behave the same way, a search pattern that works well for one user may not be optimum for another.

This is a particular issue for a reader having multiple cameras. The exemplary reader 10 uses six cameras C1-C6. Three of the cameras C4-C6, look out of a vertical window with the help of reflecting mirrors in V, and three look out of a horizontal window H. In use, a user slides a package or container 32 with a barcode 30 through a region in front of the windows. The barcode 30 may be visible to cameras behind the vertical window, or to cameras behind the horizontal window, or both. The barcode 30 may move through the center of the field-of-view of the cameras, or through one end or the other of the field-of-view.

To minimize the computational effort to locate the barcode in any of the cameras, and to therefore enable a less expensive processing solution, it is desirable to find the barcode image and decode it as efficiently as possible. The bar code reader can respond faster, maximizing scanning throughput by informing the user that the barcode has decoded (with a beep or with a blinking light) as fast as possible, enabling the user to proceed to the next barcode without delay.

Each camera assembly C1-C6 of the imaging system 12 captures a series of image frames of its respective field-of-view FV1-FV6. The series of image frames for each camera assembly C1-C6 is shown schematically as IF1, IF2, IF3, IF4, IF5, IF6 in FIG. 7. Each series of image frames IF1-IF6 comprises a sequence of individual image frames generated by the respective cameras C1-C6. As seen in the drawings, the designation IF1, for example, represents multiple successive images obtained from the camera C1. As is conventional with imaging cameras, the image frames IF1-IF6 are in the form of respective digital signals representative of raw gray scale values generated by each of the camera assembly C1-C6.

The image processor or processors 14 controls operation of the cameras C1-C6. The cameras C1-C6, when operated during an imaging system, generate digital signals 35. The signals 35 are raw, digitized gray scale values, which correspond to a series of generated image frames for each camera. For example, for the camera C1, the signal 35 corresponds to digitized gray scale values corresponding to a series of image frames IF1. For the camera C2, the signal 35 corresponds to digitized gray scale values corresponding to a series of image frame IF2, and so on. The digital signals 35 are coupled to a bus interface 42, where the signals are multiplexed by a multiplexer 43 and then communicated to a memory 44 in an organized fashion so that the processor knows which image representation belong to a given camera.

The image processors 15 access the image frames IF1-IF6 from memory 44 and search for image frames that include an imaged target bar code 30′. If the imaged target bar code 30′ is present and decodable in one or more image frames, the decoder 16 attempts to decode the imaged target bar code 30′ using one or more of the image frames having the imaged target bar code 30′ or a portion thereof. A principal feature of the present disclosure is the manner in which the processor controls the capture and/or evaluation of these images.

For any individual presentation of a target bar code 30 to the reader windows H. V, the exact orientation and manner of presentation of the target bar code 30 to the windows will determine which camera or cameras generate suitable images for decoding. However, based on human repetitive behavior, it is likely that, for example, sales persons generally or a given sales person, specifically, will develop a pattern of presentation of a target bar code 30 to the windows H, V that results in certain cameras having a much higher probability of generating an image frame that includes the imaged target bar code 30′ and is suitable for decoding the imaged bar code 30′, either alone or in conjunction with other image frames.

Each camera includes a charged coupled device (CCD), a complementary metal oxide semiconductor (CMOS), or other imaging pixel array, operating under the control of the imaging processing system 40. In one exemplary embodiment, the sensor array comprises a two-dimensional (2D) CMOS array with a typical size of the pixel array being on the order of 752×480 pixels. The illumination-receiving pixels of the sensor array define a sensor array surface secured to a printed circuit board for stability. The sensor array surface is substantially perpendicular to an optical axis of the imaging lens assembly, that is, a z axis that is perpendicular to the sensor array surface would be substantially parallel to the optical axis of the focusing lens. The pixels of the sensor array surface are disposed in an orthogonal arrangement of rows and columns of pixels.

The reader circuitry 11 includes imaging system 12, the memory 44 and a power supply 11a. The power supply 11a is electrically coupled to and provides power to the circuitry 11 of the reader. Optionally, the reader 10 may include an illumination system 60 (shown schematically in FIG. 7) which provides illumination to illuminate the effective total field-of-view to facilitate obtaining an image 30′ of a target bar code 30 that has sufficient resolution and clarity for decoding.

For each camera assembly C1-C6, the sensor array is enabled during an exposure period to capture an image of the field-of-view FV1-FV6 of the camera assembly. The field-of-view FV1-FV6 is a function of both the configuration of the sensor array and the optical characteristics of the imaging lens assembly and the distance and orientation between the array and the lens assembly.

If the target bar code 30 is within the field-of-view of a particular camera assembly, say camera C1, each image frame of the series of image frames IF1 includes an image 30′ of the target bar code 30 (shown schematically in FIG. 7). The image processors 15 and the decoding system 14 select an image frame from the series of image frames IF1-IR6 stored in the memory 44 and attempt to locate and decode a digitized, gray scale version of the image bar code 30′.

The camera assemblies C1-C6 are continuously generating respective series of image frames IF1-IF6. Since many of these captured frames IF1-IF6 will not include an imaged target bar code 30′, the image processors 15 of the image processing system 14 must analyze the stored image frames IF1-IF6 in memory 44 to find and decode.

For each camera assembly C1-C6, electrical signals are generated by reading out of some or all of the pixels of the pixel array after an exposure period generating the gray scale value digital signal 35. This occurs as follows: within each camera, the light receiving photosensor/pixels of the sensor array are charged during an exposure period. Upon reading out of the pixels of the sensor array, an analog voltage signal is generated whose magnitude corresponds to the charge of each pixel read out. The image signals 35 of each camera assembly C1-C6 represents a sequence of photosensor voltage values, the magnitude of each value representing an intensity of the reflected light received by a photosensor/pixel during an exposure period.

Processing circuitry of the camera assembly, including gain and digitizing circuitry, then digitizes and coverts the analog signal into a digital signal whose magnitude corresponds to raw gray scale values of the pixels. The series of gray scale values (GSV) represent successive image frames generated by the camera assembly. The digitized signal 35 comprises a sequence of digital gray scale values typically ranging from 0-255 (for an eight bit A/D converter, i.e., 28=256), where a 0 gray scale value would represent an absence of any reflected light received by a pixel during an exposure or integration period (characterized as low pixel brightness) and a 255 gray scale value would represent a very intense level of reflected light received by a pixel during an exposure period (characterized as high pixel brightness). In some sensors, particularly CMOS sensors, all pixels of the pixel array are not exposed at the same time, thus, reading out of some pixels may coincide in time with an exposure period for some other pixels. Additional features and characteristics of the dual window imaging processing system are disclosed in co-pending U.S. patent application Ser. No. ______, (Attorney Docket No. SYM-018581 US PRI), filed Sep. 29, 2008, inventors Bill Sackett, Brad Carlson, and Mike Slutsky, assigned to the assignee of the present invention. The aforesaid co-pending application (Attorney Docket No. SYM-018581 US PRI) is incorporated herein by reference in its entirety.

As is best seen in FIG. 7, the digital signals 35 are received by the bus interface 42 of the image processing system 40, which may include the multiplexer 43, operating under the control of an application specific integrated circuit (ASIC) 46, to serialize the image data contained in the digital signals 35. The digitized gray scale values of the digitized signal 35 are stored in the memory 44. The digital gray scale values GSV constitute a digitized gray scale version of the series of image frames IF1-IF6, which for each camera assembly C1-C6 and for each image frame is representative of the image projected by the imaging lens assembly onto the pixel array during an exposure period. If the field-of-view of the imaging lens assembly includes the target bar code 30, then a digital gray scale value image 30′ of the target bar code 30 would be present in the digitized image frame.

The decoding circuitry 14 then operates on selected image frames and attempts to decode any decodable image within the image frames, e.g., the imaged target bar code 30′. If the decoding is successful, decoded data 56, representative of the data/information coded in the target bar code 30 is then output via a data output port 58 and/or displayed to a user of the reader 10 via a display 59. Upon achieving a good read of the target bar code 30, that is, the bar code 30 was successfully imaged and decoded, the speaker 34b and/or an indicator LED 34a is activated by the bar code reader circuitry 11 to indicate to the user that the target bar code 30 has successfully read.

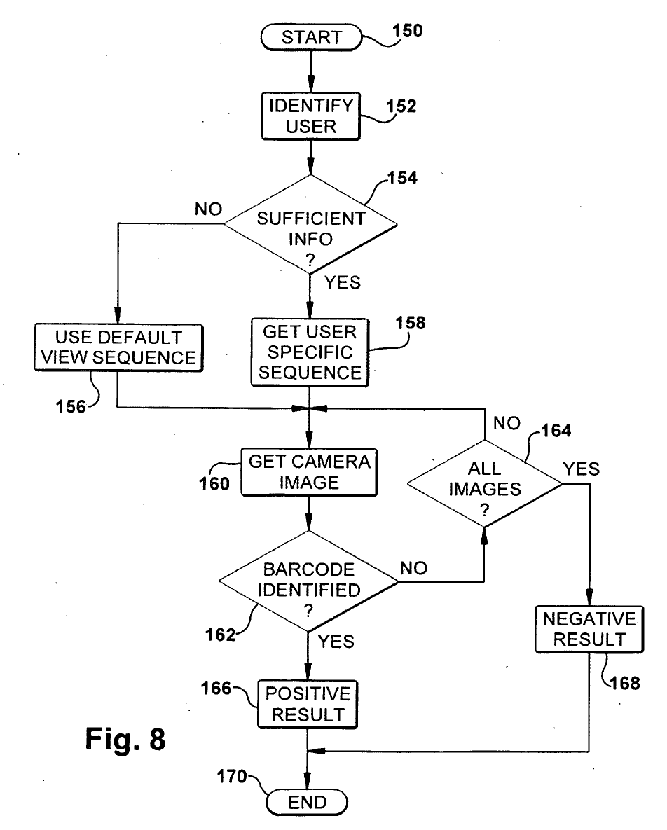

FIG. 8 represents a flow chart of a representative method of the disclosed system. The processors 15 maintain a database of past user behavior including the frequency with which users have successful reads from different cameras within the housing. An exemplary process of enhancing bar code identification beings 150 by identifying a user 152 by scanning a user identifier or keyboard entry. The process then determines 154 if enough information has been gathered for the user to make an informed prediction regarding scan tendencies and hence the order of image monitoring. If the user has insufficient data, the processors 15 use a default sequence 156 which is still better than brute force evaluation of all images in no particular order.

If enough information for a user is available, the processors 15 access 158 the database and gather a preferred image evaluation sequence. A goal of the process of FIG. 8 is to decode a bar code with greatest efficiency. A first camera image is evaluated 160. If a bar code is identified in this first image at a test 162, a positive result is indicated 166 to the user and the process ends 170.

One process would preferentially gather the images from the camera in a specified order with the most likely camera being chosen for a first set of images. The time delay in gathering and storing all images, however, may not be great. A bigger delay is evaluating the images to determine a presence of a bar code. Thus, the act of preferentially getting an image 160 most typically determines which images from a set of images gathered and stored very quickly is in determining which camera image in the sequence of stored images to check first and in what order other images are to be checked. Once a barcode is found it is decoded and the information stored or transmitted. The process can fail to find a barcode. If a determination is made 164 that all stored images are evaluated and no barcode found then a negative result is indicated 168 and either another image capture sequence performed or the information may be entered by the user manually via a keyboard of the like.

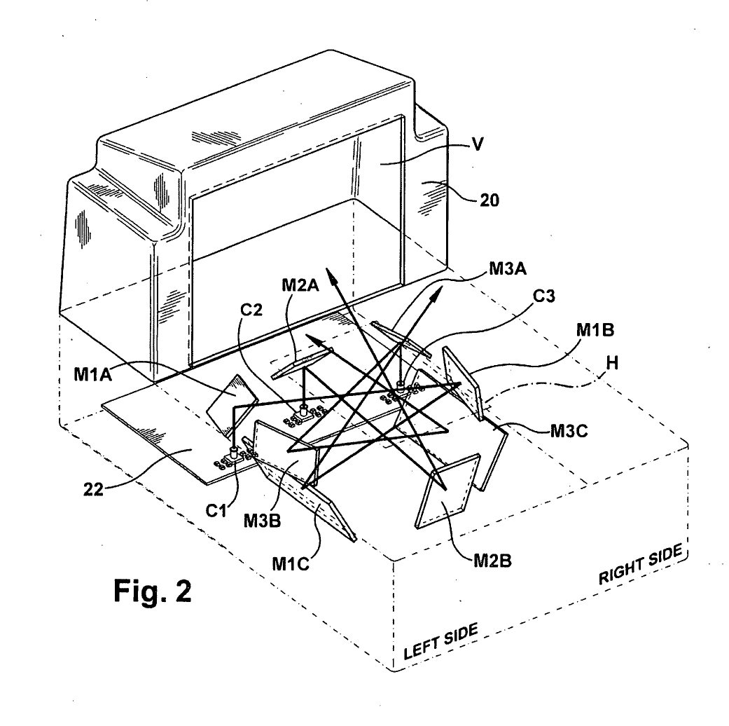

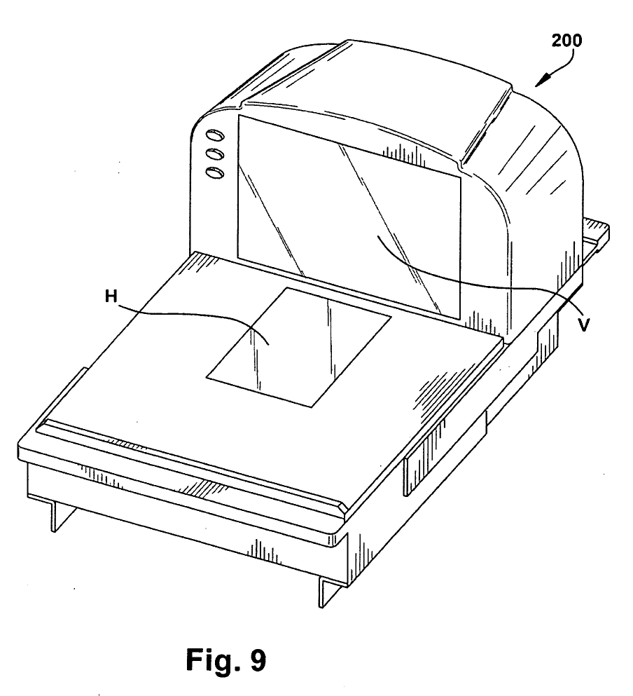

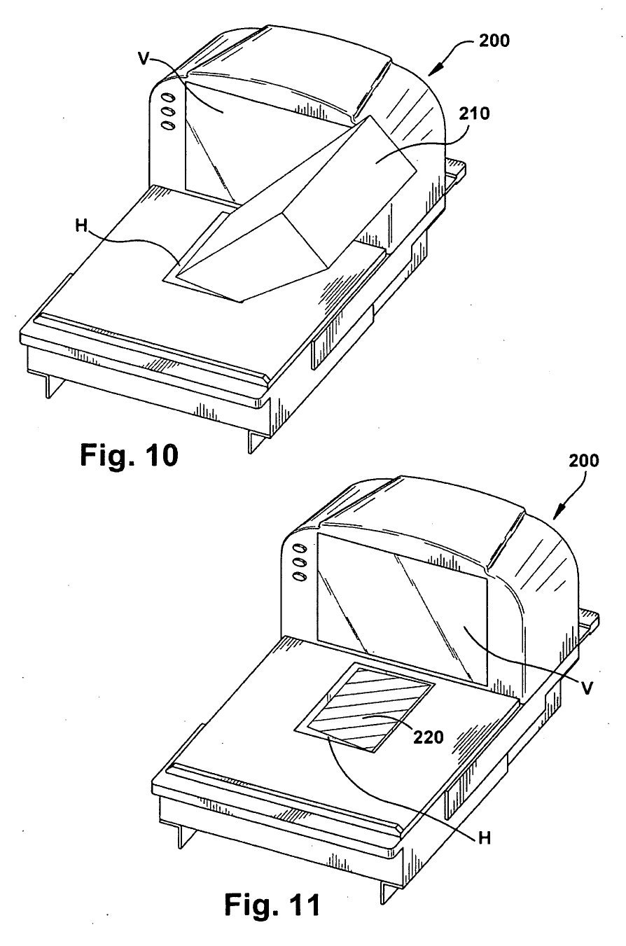

Referring now to FIG. 2 is a partial internal view of a dual window scanner 200 illustrated in FIG. 9 constructed in accordance with one example embodiment of the present disclosure. In the illustrated embodiment of FIG. 2, the dual window scanner includes the printed circuit board 22 having six imaging cameras thereon, where three cameras having a field-of-view extending from a generally horizontal window H are shown, namely C1, C2, and C3. Camera or imager C1 and its associated optics faces generally vertically upward toward an incline folding mirror MIA substantially directly overhead at a left side of the horizontal window H. The folding mirror M1A faces another inclined narrow folding mirror M1B located at a right side of the horizontal window H. The folding mirror M1B faces still another inclined wide folding mirror M1C adjacent the mirror MIA. The folding mirror M1C faces out through the generally horizontal window H toward the right side of the dual window scanner such to form an imaging field-of-view 210 illustrated in FIG. 10. As a result, an imaging pattern 220 resulting from the field-of-view projected from camera C1 is produced, filling the scanning area illustrated on the horizontal window H in FIG. 11.

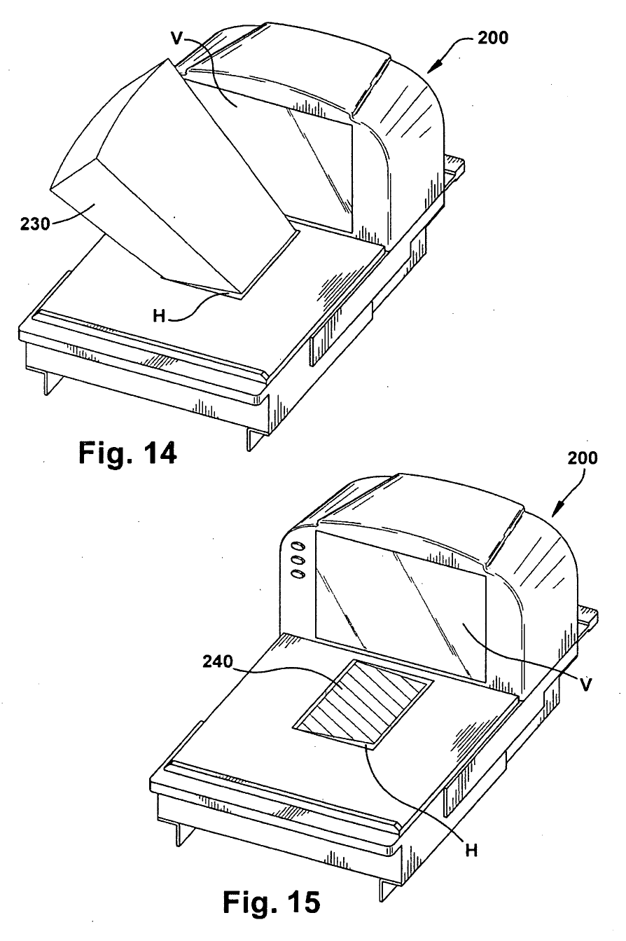

In FIG. 2 camera or imager C3 and its associated optics is mirror symmetrical to imager C1. Camera C3 faces generally vertically upward toward an incline folding mirror M3A substantially directly overhead at a right side of the horizontal window H. The folding mirror M3A faces another inclined narrow folding mirror M3B located at a left side of the horizontal window H. The folding mirror M3B faces still another inclined wide folding mirror M3C adjacent the mirror M3A. The folding mirror M3C faces out through the generally horizontal window H toward the left side of the dual window scanner such to form an imaging field-of-view 230 illustrated in FIG. 14. As a result, an imaging pattern 240 resulting from the field-of-view projected from camera C3 is produced, filling the area illustrated on the horizontal window H in FIG. 15.

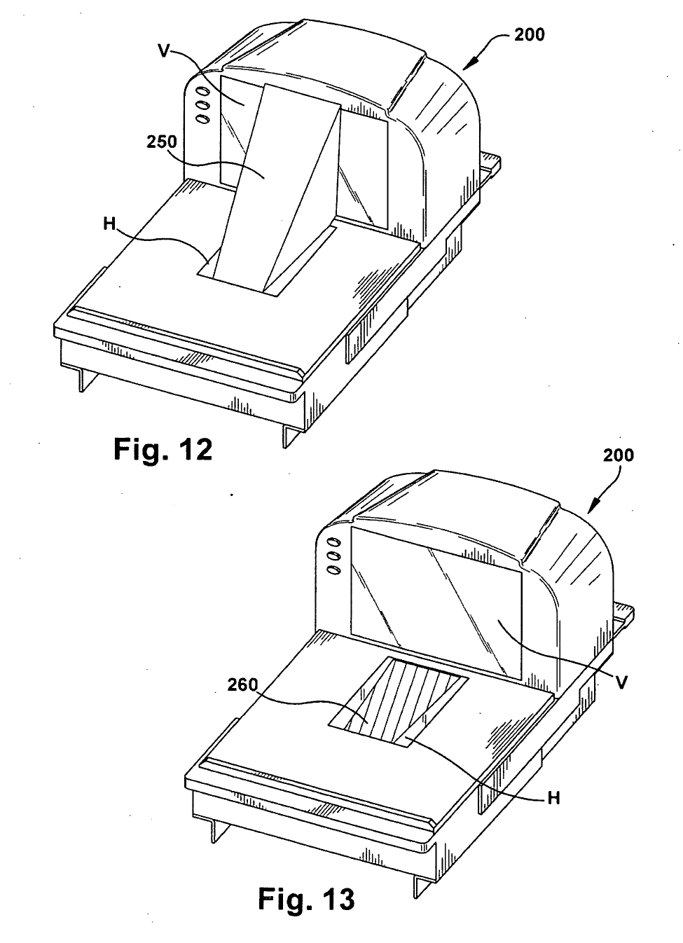

Imager or camera C2 and its associated optics are located generally centrally between imagers C1 and C3 and their associated optics. Imager C2 faces generally vertically upward toward an inclined folding mirror M2A substantially directly overhead generally centrally of the horizontal window H at one end thereof. The folding mirror M2A faces another inclined folding mirror M2B located at the opposite end of the horizontal window H. The folding mirror M2B faces out through the window H in an upward direction toward the vertical window V in the housing 20 such to form an imaging field-of-view 250 illustrated in FIG. 12. As a result, an imaging pattern 260 resulting from the field-of-view projected from camera C2 is produced, filling the area illustrated on the horizontal window H in FIG. 13.

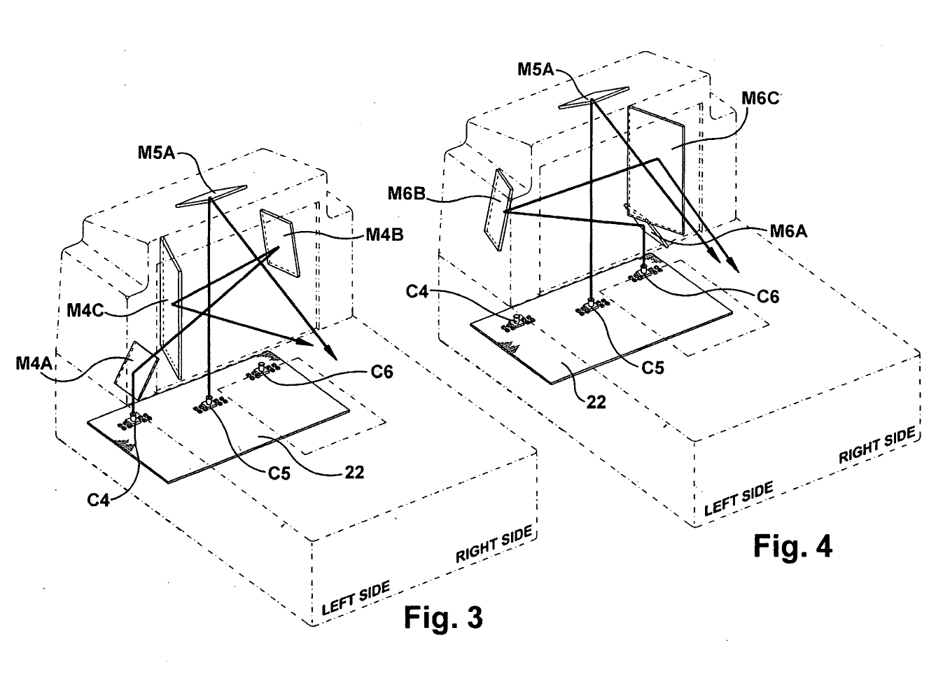

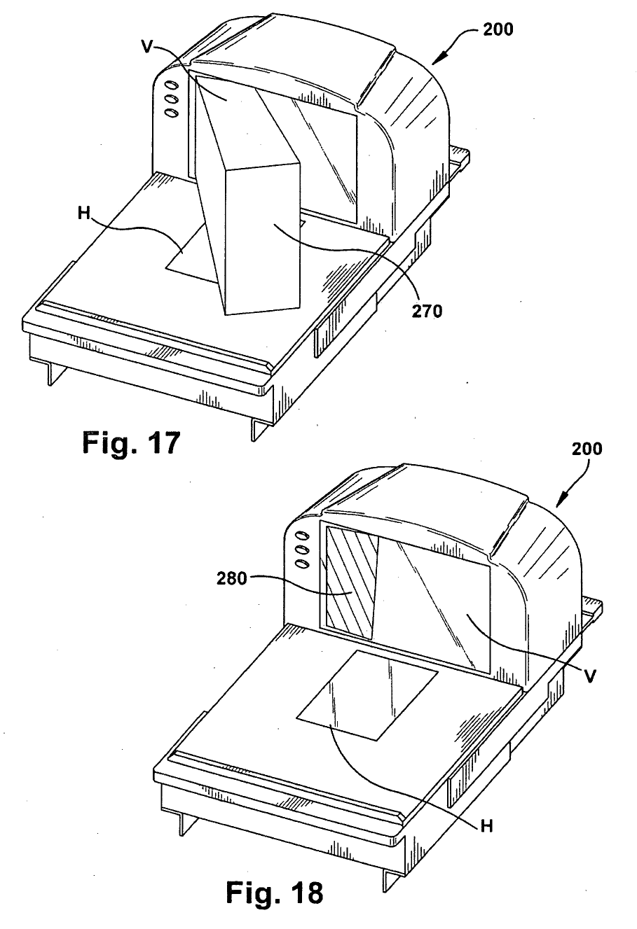

Referring now to FIGS. 3 and 4 are partial internal views of the dual window scanner 200 illustrated in FIG. 9 constructed in accordance with one example embodiment of the present disclosure. In the illustrated embodiment of FIG. 3, the dual window scanner includes the printed circuit board 22 having six imaging cameras thereon, where three cameras having a field-of-view extending from a generally vertical window V are shown, namely C4, C5, and C6. Camera or imager C4 and its associated optics faces generally vertically upward toward an incline folding mirror M4A substantially directly overhead at a left side of the vertical window V. The folding mirror M4A faces another inclined narrow folding mirror M4B located at a right side of the vertical window V. The folding mirror M4B faces still another inclined wide folding mirror M4C adjacent the mirror M4A. The folding mirror M4C faces out through the generally vertical window V toward the right side of the dual window scanner such to form an imaging field-of-view 270 illustrated in FIG. 17. As a result, an imaging pattern 280 resulting from the field-of-view projected from camera C4 is produced, filling the area illustrated on the vertical window V in FIG. 18.

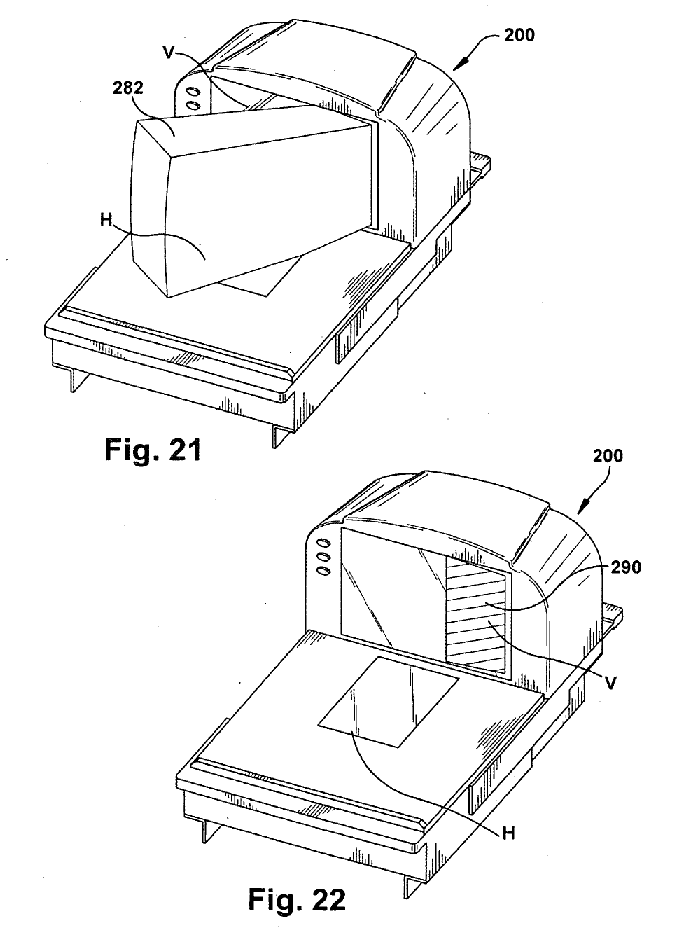

In FIG. 4 camera or imager C6 and its associated optics is mirror symmetrical to imager C4. Camera C6 faces generally vertically upward toward an incline folding mirror M6A substantially directly overhead at a right side of the vertical window V. The folding mirror M6A faces another inclined narrow folding mirror M6B located at a left side of the vertical window V. The folding mirror M6B faces still another inclined wide folding mirror M6C adjacent the mirror M6A. The folding mirror M6C faces out through the generally vertical window V toward the left side of the dual window scanner such to form an imaging field-of-view 282 illustrated in FIG. 21. As a result, an imaging pattern 290 resulting from the field-of-view projected from camera C6 is produced, filling the area illustrated on the vertical window V in FIG. 22.

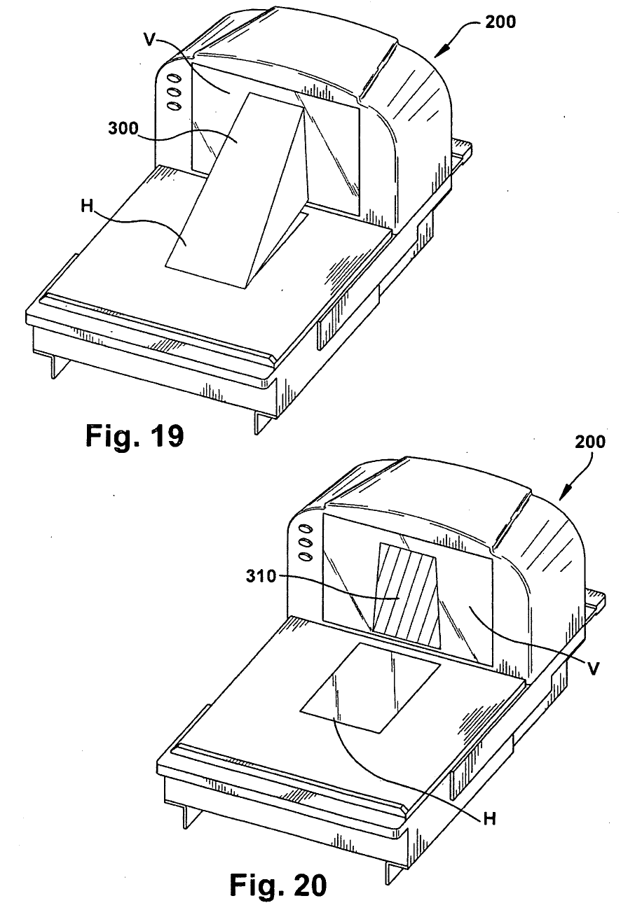

In FIG. 4, imager or camera C5 and its associated optics are located generally centrally between imagers C4 and C6 and their associated optics. Imager C5 faces generally vertically upward toward an inclined folding mirror M5A substantially directly overhead generally centrally of the vertical window V at one end thereof. The folding mirror M5A faces out through the window V in a downward direction toward the horizontal window H in the housing 20 such to form an imaging field-of-view 300 illustrated in FIG. 19. As a result, an imaging pattern 310 resulting from the field-of-view projected from camera C5 is produced, filling the area illustrated on the vertical window V in FIG. 20.

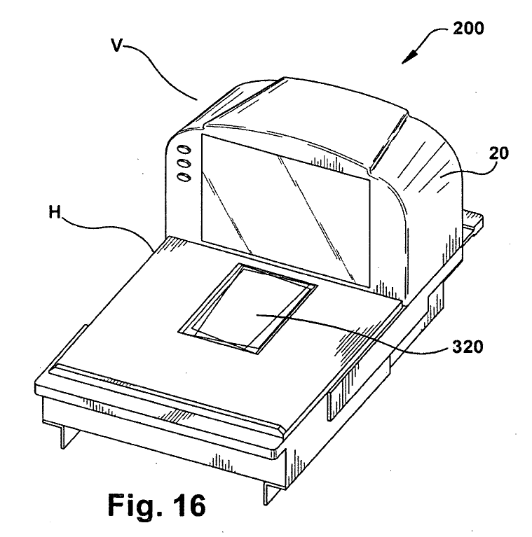

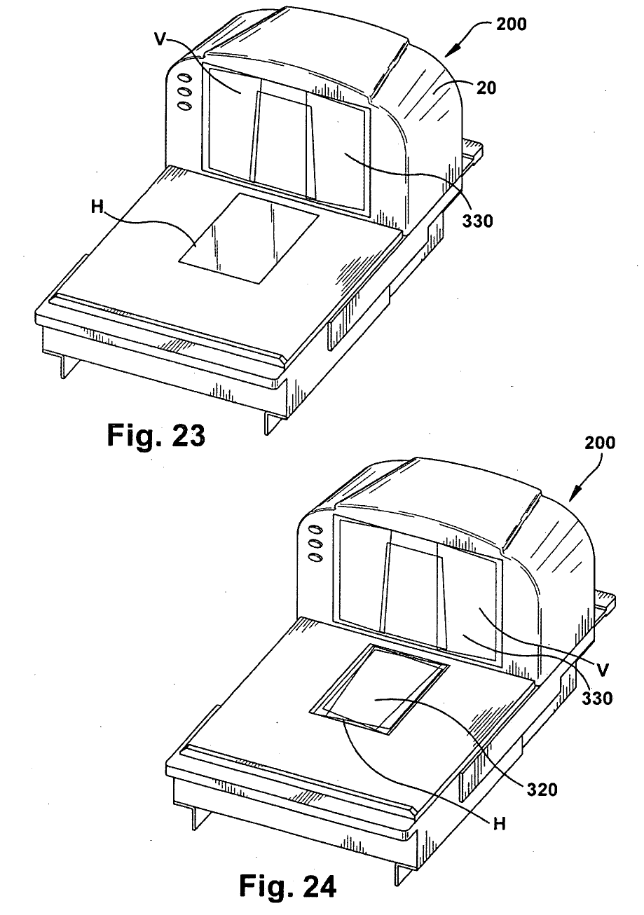

Collectively the cameras C1-C6 located on the single printed circuit board 22 within housing 20 of the dual window scanner 200 collectively cover along the horizontal window H substantially the entire surface area 320 through the field-of-views of cameras C1-C3, as illustrated in FIG. 16. While substantially the entire surface area 330 of the vertical window V is covered through the field-of-views of cameras C4-C6, as illustrated in FIG. 23. A target bar code 30 can be presented anywhere at or near the surface areas 320 or 330 for a successful decoding. The field-of-views of cameras C1-C6 forming surface areas 320 and 330, collectively illustrated in FIG. 24 produce virtually no holes in the scan pattern of the imagers in either the vertical or horizontal windows V, H of the dual window scanner 200.

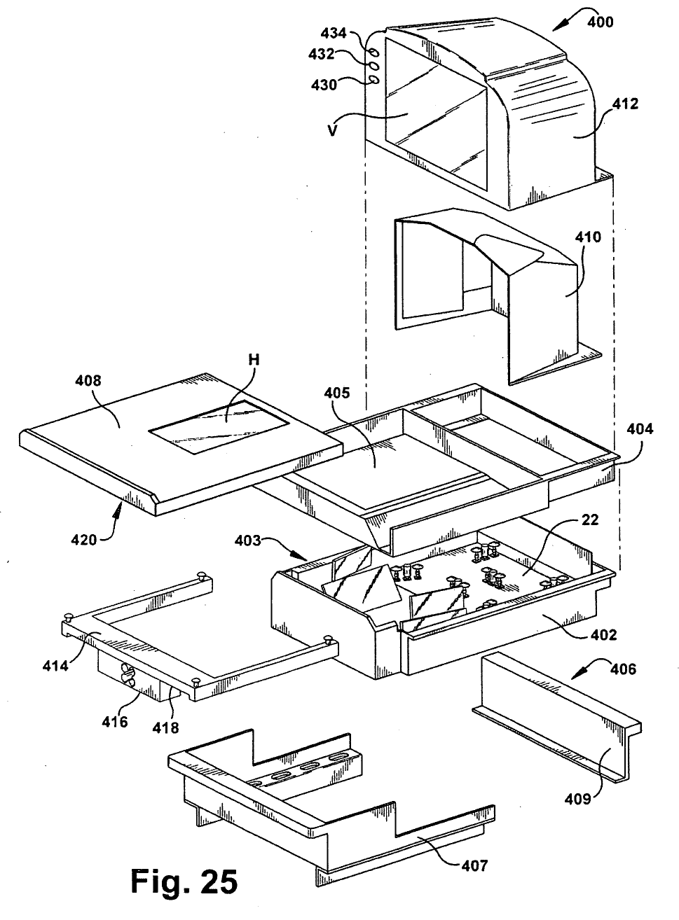

FIG. 25 illustrates an exploded assembly view of a dual window scanner 400 constructed in accordance with one example embodiment of the present disclosure. The dual window scanner 400 comprises a molded lower housing 402, a molded lower housing cover 404, a housing extender assembly 406, a horizontal platter 408, a molded vertical mirror support 410, a molded vertical outer housing 412, and a scale assembly 414.

The molded lower housing 402 provides rigidity for imaging cameras and scale assemblies 414 that are used to weigh objects and packages presented to the dual window scanner 400. The molded lower housing 402 further provides support to the cameras C1-C6 and interface of the printed circuit board 22, and a lower horizontal mirror array 403 that supports some of the mirrors illustrated in FIG. 2. The molded lower housing 402 is adapted to accommodate different sized vertical mirror supports 410, e.g., one size for imaging a five-sided object and a different size for imaging a six-sided object and long, medium, and short size versions of the dual window scanner through the changing of lengths of the housing extender assembly 406. In particular, the change in the length occurs in a front assembly 407 as it attaches to a rear panel 409 in forming the extender assembly 406.

The molded lower housing cover 404 supports an upper horizontal mirror array supporting some mirrors illustrated in FIG. 2. The molded lower housing cover 404 further supports an inner horizontal window 405 placed over the horizontal upper and lower mirror arrays during assembly. The molded lower housing cover 404 also provides sealing and drain holes for the passage of fluids exposed to the dual window scanner 400 by users inadvertently during operation. The molded lower housing cover 404 is adapted to accommodate different sized vertical mirror supports 410, e.g., one size for imaging a five-sided object and a different size for imaging a six-sided object and long, medium, and short size versions of the dual window scanner 400 through the changing of lengths of the housing extender assembly 406 by changing the length of the front assembly 407.

The horizontal platter 408 contains a horizontal scratch proof window H that allows the passing of imaging cameras field-of-views for imaging a target bar code 30 as also illustrated in FIGS. 10-13 and 14-15. The horizontal platter 408 also serves as a weigh platter when a scale assembly 414 is present for weighing objects that are typically sold by some weight unit of measure. The scale assembly 414 weighs the objects to be measured by the dual window scanner 400 through a strain gauge 416 adapted to an underside 418 of the scale assembly and between front assembly 407 of the housing extender assembly 406 and bottom 420 of the platter 408. The horizontal platter 408 is durably constructed and removably adapted to the molded lower housing 402 for cleaning spill and dust accumulated on the inner horizontal window 405 and molded lower housing cover 404.

The molded vertical mirror support 410 is provided in different tower heights, the larger being for imaging a six-sided object and the smaller being for imaging a five-sided object. Other than changes in scale, the molded vertical mirror support 410 for the five or six sided objects have the same construction illustrated in FIG. 25. The molded vertical mirror support 410 provides support to the vertical mirror array, namely mirrors M4A, M4B, M4C, M5A, M6A, M6B, and M6C illustrated in FIGS. 3 and 4.

Also illustrated in FIG. 25 is the molded vertical outer housing 412, having two versions, the larger being for imaging a six-sided object and the smaller being for imaging a five-sided object. Other than changes in scale, the molded vertical outer housing 412 for the five or six sided objects have the same construction illustrated in FIG. 25. The vertical outer housing 412 further comprises inner vertical window (not shown) located inside the housing behind an outer vertical window V that allow the passing of imaging cameras field-of-views for imaging a target bar code 30, as also illustrated in FIGS. 17-22. Supported by the vertical outer housing 412 are selective mode switch 430, display indicator 432 such as a light emitting diode (LED), and audible alarm 434 such as a speaker for notifying the user of a proper scan. The materials for forming the dual window scanner 400 include metals such as sheet or cast or hard plastics could equally be used in place of the metal materials without departing from the spirit and scope of the claimed invention.

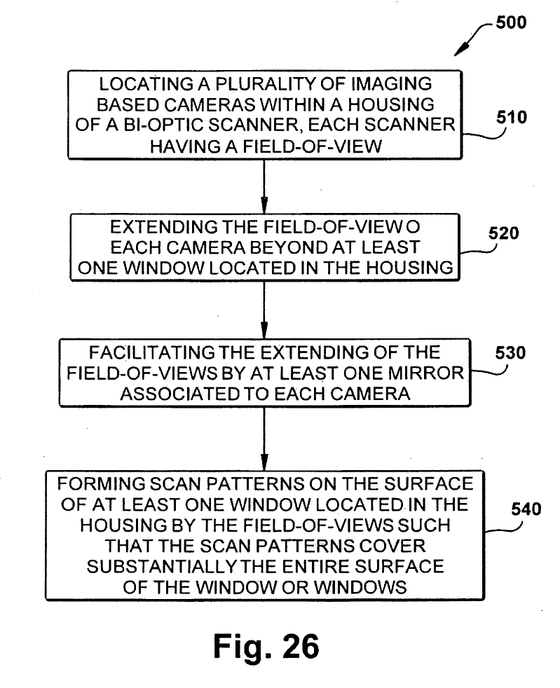

Illustrated in FIG. 26 is a flowchart of an exemplary embodiment of the present disclosure depicting a process 500 for imaging a target bar code 30 with a dual window imaging scanner. At 510, the process 500 comprises the step of locating a plurality of imaging based cameras within a housing of a dual window scanner, each scanner having a respective field-of-view. At 520, the process 500 comprises the step of extending the field-of-view of each camera beyond at least one window located in the housing. At 530, the process 500 comprises the step of facilitating the extending of the field-of-views by at least one mirror associated to each camera. At 540, the process 500 comprises the step of forming scan patterns on the surface of the at least one window located in the housing by the field-of-views such that the scan patterns cover substantially the entire surface of the window or windows.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. A dual window scanner for imaging a target bar code on a target object, the dual window scanner comprising:
a housing supporting two transparent windows and defining an interior region, a target object being presented in relation to the housing for imaging a target bar code;
an imaging system including a plurality of cameras wherein each camera is positioned within the housing interior region and defines a field-of-view which is different than a field-of-view of each other camera of the plurality of cameras, each camera including a sensor array; and
each camera in said plurality of cameras located within in the hosing for directing the respective field-of-views that the field-of-views substantially fill the surface of said two transparent windows.

2. The dual window scanner of claim 1 wherein said two transparent windows includes a least one substantially vertically oriented window and one substantially horizontally oriented window, the field of views being projected beyond said substantially vertical and horizontal windows in directions for scanning various sides of a package as it is swiped through a scan field formed by the fields-of-view.

3. The dual window scanner of claim 1 wherein the plurality of cameras are adapted to a single printed circuit board located within said housing.

4. The dual window scanner of claim 3 wherein each camera of said plurality of cameras and their associated optics are oriented in an upward direction away from said printed circuit board with their respective field-of-view oriented toward at least one mirror.

5. The dual window scanner of claim 1 further comprising a scale assembly for measuring the weight of an object presented to the dual window scanner, the scale assembly being located between a horizontal platter and a lower housing.

6. A method of operating dual window scanner for imaging a target bar code comprising:
locating a plurality of imaging based cameras within a housing of a dual window scanner each scanner having a respective field-of-view;
extending the field-of-view of each camera beyond at least one window located in the housing;
facilitating the extending of the field-of-views by at least one mirror associated to each camera; and
forming scan patterns on the surface of the at least one window located in the housing by the field-of-views such that the scan patterns cover substantially the entire surface of the window or windows.

7. The bar code reader method of claim 6 further comprising locating at least one window in a substantially horizontal position in said housing and locating at least one window in a substantially vertical position in said housing.

8. The method of claim 6 further comprising coupling the plurality of imaging based cameras to a single printed circuit board located within said housing.

9. The method of claim 8 further comprising orienting each of said cameras of said plurality of cameras and their associated optics in an upward direction away from said printed circuit board with their respective field-of-view oriented toward said at least one mirror

10. The method of claim 6 further comprising providing a scale assembly for measuring the weight of an object presented to the dual window scanner and locating the scale assembly between a horizontal platter and a lower housing.

11. A dual window scanner for imaging a target bar code on a target object, the dual window scanner comprising:
housing means supporting two transparent windows and defining an interior region, a target object being presented in relation to the housing means for imaging a target bar code;
imaging means including a plurality of camera assembly means wherein each camera assembly means is positioned within the housing means interior region and defines a field-of-view which is different than a field-of-view of each other camera assembly means of the plurality of camera assembly means,
sensing means for each camera assembly means including a sensor array and an imaging lens assembly for focusing the field-of-view of the camera assembly means onto the sensor array; and
reflective means associated with each camera assembly means for directing the respective field-of-views such that the field-of-views of some of the cameras in the plurality of cameras substantially fill the surface of one of said transparent windows and the field-of-views of the remaining cameras in the plurality of cameras substantially fill the surface of the other of said transparent windows.

12. A dual window scanner for imaging a target bar code on a target object, the dual window scanner comprising:
a housing comprising a substantially vertical window supported in an upper housing portion and a substantially horizontal window supported in a lower housing portion, the upper and lower housing portions defining an interior region of the dual window scanner;
an imaging system including a plurality of cameras positioned on a single printed circuit board within the housing interior region, each camera is positioned within the housing interior region and defines a field-of-view which is different than a field-of-view of each other camera of the plurality of cameras, each camera including a sensor array;
at least one mirror associated with at least one camera in said plurality of cameras; and
the field-of-views forming an imaging pattern substantially filling the surface of said horizontal and vertical windows, the field-of-views being projected beyond said substantially vertical and horizontal windows in directions for scanning various sides of a package as it is swiped through a scan field formed by the fields-of-view.

13. The dual window scanner of claim 12 wherein each camera of said plurality of cameras and their associated optics are oriented in an upward direction away from said printed circuit board with their respective field-of-view oriented toward said at least one mirror.

14. The dual window scanner of claim 12 further comprising a scale assembly for measuring the weight of an object presented to the deal window scanner, the scale assembly being located below a horizontal platter in said lower housing portion.

15. The dual window scanner of claim 12 wherein said plurality of cameras comprise three lower cameras, each lower camera having a field-of-view extending from said lower window and three upper cameras having a field-of-view extending from said upper window.

16. The dual window scanner of claim 13 wherein said plurality of cameras comprise three lower cameras, each lower camera having a field-of-view extending from said lower window and three upper cameras having a field-of-view extending from said upper window.

17. The dual window scanner of claim 15 wherein said three lower cameras comprises two outwardly located lower cameras and one relatively centrally located lower camera about said outwardly located lower cameras on said printed circuit board, and said three upper cameras comprises two outwardly located upper cameras and one relatively centrally located upper camera about said outwardly located upper cameras on said printed board.

18. The dual window scanner of claim 17 wherein said at least one mirror associated with at least one camera comprises three mirrors for each of said outwardly located outer lower and upper cameras.

19. The dual window scanner of claim 17 wherein said at least one mirror associated with at least one camera comprises two mirrors or said centrally located lower camera.

20. The dual window scanner of claim 17 wherein said imaging patter is a composite of three individual imaging patters formed on said vertical window formed by said three upper cameras and three individual imaging patterns formed on said horizontal window by said three lower cameras.
